(19) United States
(12) Patent Application Publication
(10) Pub. No.: US 2022/0189335 A1
(43) Pub. Date: Jun. 16, 2022

(54) MOTION FEEDBACK DEVICE

(71) Applicant: University of Kentucky Research Foundation, Lexington, KY (US)

(72) Inventors: Matthew Phillip Ruffner, Lexington, KY (US); Kevin D. Donohue, Lexington, KY (US); Michael J. Sikora, Lexington, KY (US)

(21) Appl. No.: 17/689,458

(22) Filed: Mar. 8, 2022

Related U.S. Application Data
(63) Continuation-in-part of application No. 16/843,542, filed on Apr. 8, 2020.
(60) Provisional application No. 62/836,955, filed on Apr. 22, 2019.

(51) Int. Cl. G09B 19/00; G09B 15/00; H04R 1/02; G10H 1/00; G10H 1/46; G10H 1/053; G06F 3/01

(52) U.S. Cl. CPC G09B 19/003; G09B 15/00; H04R 1/025; A63B 71/0622; G10H 1/46; G10H 1/053; G06F 3/016; G10H 1/0008

(57) ABSTRACT

A motion feedback device includes a housing, a speaker and a control module carried by said housing. The control module includes a controller and a motion sensor. The controller is configured to include a mapping adapted for the creation of sound in response to any user-produced movement of the housing as detected by the motion sensor. This allows for continuous original sound generation or composition based upon the user produced movements of the housing.

### RELATED APPLICATION

This application is a continuation-in-part of U.S. patent application Ser. No. 16/843,542 filed on Apr. 8, 2020, which claims priority to U.S. Provisional Patent Application Serial No. 62/836,955 filed on Apr. 22, 2019, all of which are hereby incorporated by reference in their entirety.

### TECHNICAL FIELD

This document relates generally to a programmable electronic device that functions as an interface for creating sound through motion with audio, visual and/or haptic feedback.

### BACKGROUND

People more readily engage in activities that exhibit noticeable progress, and progress is enhanced through coaching/teaching that provides appropriate and timely feedback. The motion feedback device disclosed in this document is targeted at providing this kind of feedback for musical and physical achievements. This intelligent device transforms kinetic details of specific positions, gestures, motions into acoustic, visual and haptic details that can be more easily perceived by the human brain. The device is programmable and the motion-position transformations and feedback details can be tailored to help the user better understand the context of a specific motion, or the precision with which the specific motion was achieved.

Potential applications of the motion feedback device include, but are not limited to: musical instruction and composition, sports training, physical rehabilitation and music therapy.

### SUMMARY

In accordance with the purposes and benefits described herein, a motion feedback device is provided. That motion feedback device comprises a housing, a speaker and a control module carried by the housing. The control module includes a controller and a motion sensor. The controller is configured to include a mapping adapted for the creation of sound in response to any user-produced movement of the housing as detected by the motion sensor.

In one or more of the many possible embodiments of the motion feedback device, the mapping relates (a) a pitch angle of the housing to a first sound characteristic, (b) a roll angle of the housing to a second sound characteristic and (c) a yaw angle of the housing to a third sound characteristic. The first, second and third sound characteristics may be selected from a group of sound characteristics consisting of musical note/frequency, volume and timber.

In one of the many possible embodiments, the controller is configured so that the user-produced movement of the housing creates the sound in real time having a musical note/frequency determined by a pitch angle of the housing, a volume determined by a roll angle of the housing and a timber determined by a yaw angle of the housing. In addition, the velocity of the motion can be mapped to effects such as decay of the time envelope of the sound produced with new orientation reached.

In other possible embodiments, the controller is configured so that the user-produced movement of the housing creates the sound in real time having a musical note/frequency determined by a pitch angle of the housing, a timber determined by a roll angle of the housing and a volume determined by a yaw angle of the housing.

In one of the many possible embodiments, the controller is configured so that the user-produced movement of the housing creates the sound in real time having a musical volume determined by a pitch angle of the housing, a musical note/frequency determined by a roll angle of the housing and a timber determined by a yaw angle of the housing.

In one of the many possible embodiments, the controller is configured so that the user-produced movement of the housing creates the sound in real time having a musical volume determined by a pitch angle of the housing, a timber determined by a roll angle of the housing and a musical note/frequency determined by a yaw angle of the housing.

In one of the many possible embodiments, the controller is configured so that the user-produced movement of the housing creates the sound in real time having a musical timber determined by a pitch angle of the housing, a musical note/frequency determined by a roll angle of the housing and a volume determined by a yaw angle of the housing.

In one of the many possible embodiments, the controller is configured so that the user-produced movement of the housing creates the sound in real time having a musical timber determined by a pitch angle of the housing, a volume determined by a roll angle of the housing and a musical note/frequency determined by a yaw angle of the housing.

In other possible embodiments, the pitch of the device can be mapped into a frequency, the roll into volume and shaking in the yaw direction can be mapped into vibrato or pitch bending.

In accordance with another aspect, a method of music creation is provided. That method includes the steps of (a) using the motion feedback device as described in this document augmented visual and haptic units to help guide user motion timing and spatial orienting of the motion device and (b) generating audio feedback as the music creation in response to the user-produced motion and the spatial orienting of the motion feedback device.

In one of the many possible embodiments for using the augmented unit is to place a series of markers in a room and an optical projection unit, such as a laser pointer, of the device can be used to help guide the motions to achieve the orientations to produce a desired sound or sound sequence. The haptic unit of the device can be programmed or controlled by a teacher to provide beat or timing guide on when to make the motions and guide the velocity between motions.

In the following description, there are shown and described several preferred embodiments of the motion feedback device and the related methods. As it should be realized, the motion feedback device and the related methods are capable of other, different embodiments and their several details are capable of modification in various, obvious aspects all without departing from the motion feedback device and methods as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the patent specification, illustrate several aspects of the method and together with the description serve to explain certain principles thereof.

FIG. 1 is a perspective view of one possible embodiment of the motion feedback device.

FIG. 2 is a schematic block diagram of one possible embodiment of the motion feedback device providing different audio, visual and haptic feedback in response to different user-produced movement or motion of the device.

FIG. 3 is an illustration of the motion feedback device configured for enhancing or improving a user's golf swing.

FIG. 4 is a schematic block diagram of another possible embodiment of the motion feedback device wherein the device is configured or adapted for sports training.

FIG. 5 is an illustration of the motion feedback device configured for physical rehabilitation and, more specifically, for restoring range of arm motion of the user.

FIG. 6 is a schematic block diagram of a remotely located companion component which forms a part of an alternative embodiment of the motion feedback device used for physical rehabilitation.

FIG. 7 is a perspective view of a USB data/power interface for the companion component illustrated in FIG. 6.

FIG. 8 is a schematic block diagram of another possible embodiment of the motion feedback device wherein the device is configured for music therapy.

FIG. 9 is a perspective view of one possible embodiment of the motion feedback device adapted for music therapy and bilateral stimulation.

FIG. 10 is a perspective view illustrating the pitch angle, roll angle and yaw angle axes of the motion feedback device.

FIG. 11 is a schematic representation showing how the laser pointer of the device is used to follow one or more markers in the room to provide a desired sound or sequence of sounds.

### DETAILED DESCRIPTION

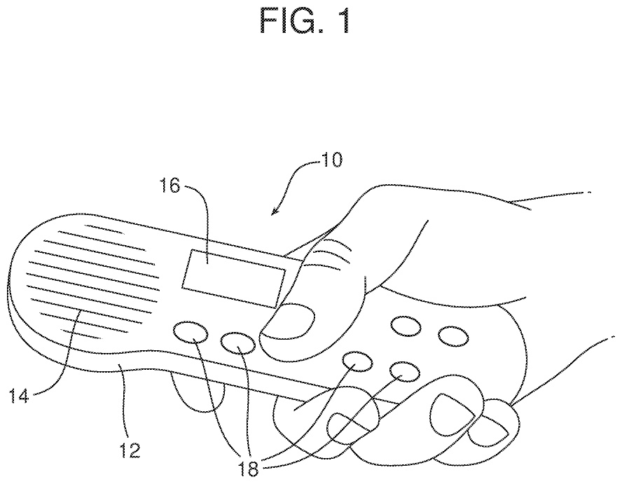

Reference is now made to FIG. 1 which illustrates one possible embodiment of a motion feedback device 10 that may be configured to provide users with one or more modes of feedback before, during and after certain user-produced positions and motions have been achieved. Thus, the device 10 facilitates a multisensory understanding of the quality and accuracy with which the motion was performed or the position achieved.

As will become apparent from the following description, the device 10 may be programmed to convert a movement, described by motion and position parameters (either from a specific motion, series of motions, or arbitrary movement), to a particular feedback fingerprint. A feedback fingerprint is a combination of haptic, acoustic, and visual feedback that allows the user to intuitively perceive a richer set of details about the performed movement. The way in which the feedback fingerprint is generated can vary and be adjusted for multiple applications and markets.

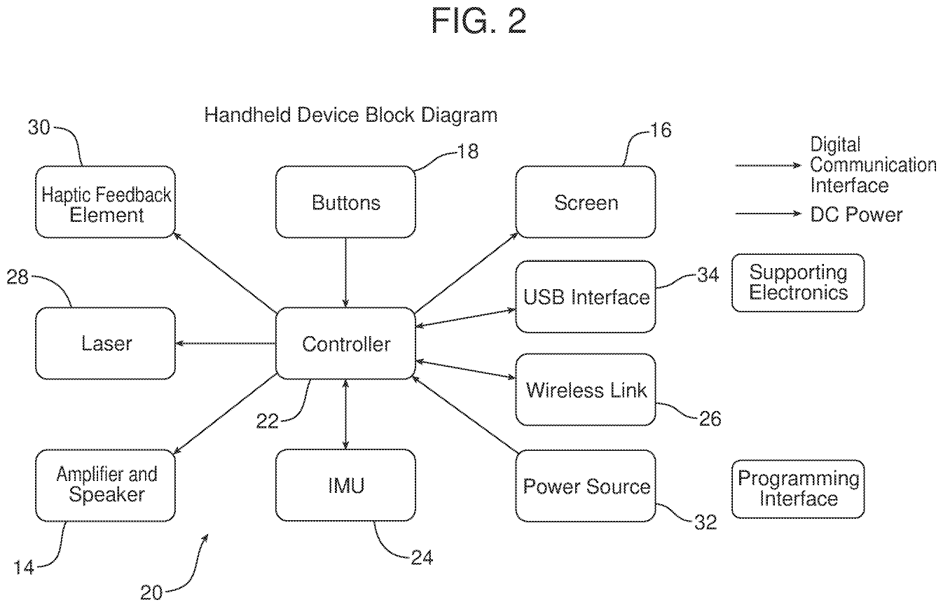

As illustrated in FIGS. 1 and 2, the motion feedback device 10 includes a housing 12 made from any appropriate, lightweight material. The housing 12 carries an amplifier and speaker 14, a display screen 16 and various operator interface or control actuators 18, which may take the form of buttons, knobs, slides or other human interface devices adapted to allow a user to adjust the operation of the device 10 as desired.

The motion feedback device 10 also includes a control module that is illustrated in FIG. 2 and generally designated by reference numeral 20. More specifically, the control module 20 includes a controller 22, a motion sensor 24, and a wireless communication feature 26 of a type known in the art that is adapted for wireless communication.

The controller 22 may comprise a computing device, such as a dedicated microprocessor or an electronic control unit (ECU) operating in accordance with instructions from appropriate control software. Thus, it should be appreciated that the device 10 may incorporate hardware and/or software control. In at least one possible embodiment, the controller 22 comprises one or more processors, one or more memories and one or more network interfaces all in communication with each other over one or more communications buses.

The motion sensor 24 may comprise one or more accelerometers or other motion sensor devices of a type known in the art and adapted to sense, in real time, the user-produced movement or motion of the housing 12.

The motion feedback device 10 may also include a laser 28, such as a laser pointer of the type well known in the art (note laser 28 and laser beam B in FIG. 1). The laser 28 is adapted to provide remote visual feedback: that is, a visual indication of the physical feature in the environment toward which the device 10 is pointed.

The motion feedback device 10 may also include a haptic feedback element 30, of a type known in the art to provide any desired haptic feedback to the user. Haptic feedback elements 30 include, but are not necessarily limited to vibration motors, piezoelectric and linear actuators, stepper motors, air vortex rings, skin electrodes and combinations thereof. In any embodiment including the haptic feedback element 30, the controller 22 may be configured to produce different haptic feedback through the haptic feedback element in response to the different user-produced movement or motion of the housing 12.

As illustrated in FIG. 2, the motion feedback device 10 may include a power source 32, such as, for example, batteries or capacitors carried by the housing 12. Alternatively or in addition, the device 10 may include a power cord (not shown) adapted for connection to a remotely located power source such as, but not necessarily limited to a battery pack or an electrical wall outlet.

As further illustrated in FIG. 2, the housing 12 of the device 10 may also carry a USB interface 34 that allows for direct physical connection, via a USB cord, of the controller 22 carried by the housing to remotely located electronic devices such as a remotely located speaker, a visual display, a computer or the like.

The motion feedback device 10 has a number of potential applications including, for example, music education and entertainment. In this application, the object is the sound created (musical), and the remote visual feedback is provided by the laser 28 and the haptic feedback provided by element 30 are used to direct the position and timing of the motion for this purpose. More specifically, the laser 28 is used to point at objects associated with musical notes on a staff or classroom whiteboard. Feedback from the haptic feedback element 30 then provides pulses, patterns, and fluctuating levels of vibration, force, or electrotactical stimulation to give the user complementary signals related to the musical/educational object. Haptic feedback in this case is given to the user when a proper technique is achieved or to maintain timing. The device 10 allows novice users to perform simple musical expressions quickly, while also allowing complex musical expressions with practice.

For instructional use the device 10 may be handheld and used by teachers and students. Collaboration and composition would be capable if both students and teachers were equipped with a set of these devices 10. The wireless communication feature 26 allows for simultaneous musical collaboration, where multiple devices 10 communicate to share a synchronized metronome signal. This can be computer driven or master control given to the teacher. The students can feel this metronome signal with haptic feedback from the haptic feedback element 30. The remote visual feedback can be directed by the instructor as well, where students follow the positions pointed to by the teacher. The wireless communication feature 26 can also be used to transmit information about each device's feedback state. Any given device 10 can also receive and combine the feedback fingerprints of each transmitting device for a symphony-like effect. The wireless communication feature 26 also facilitates musical composition, where the students' notes are sent to a computer through a designated receiving device and displayed upon a musical score.

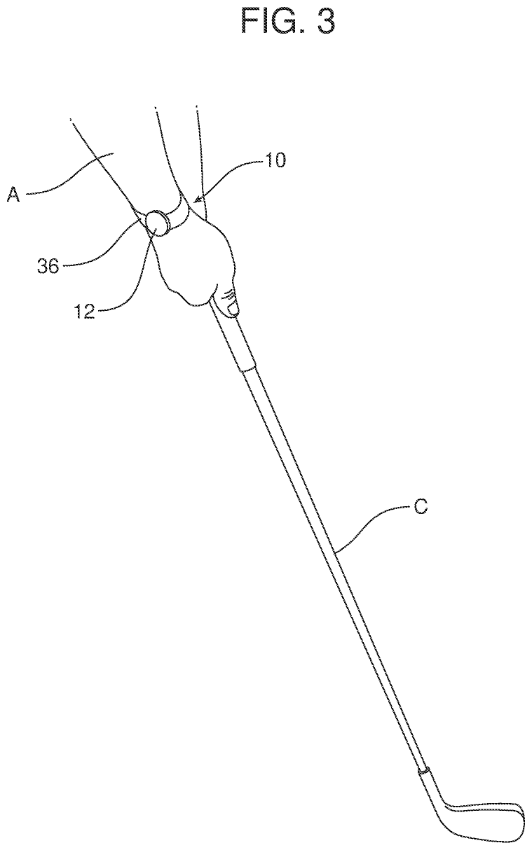

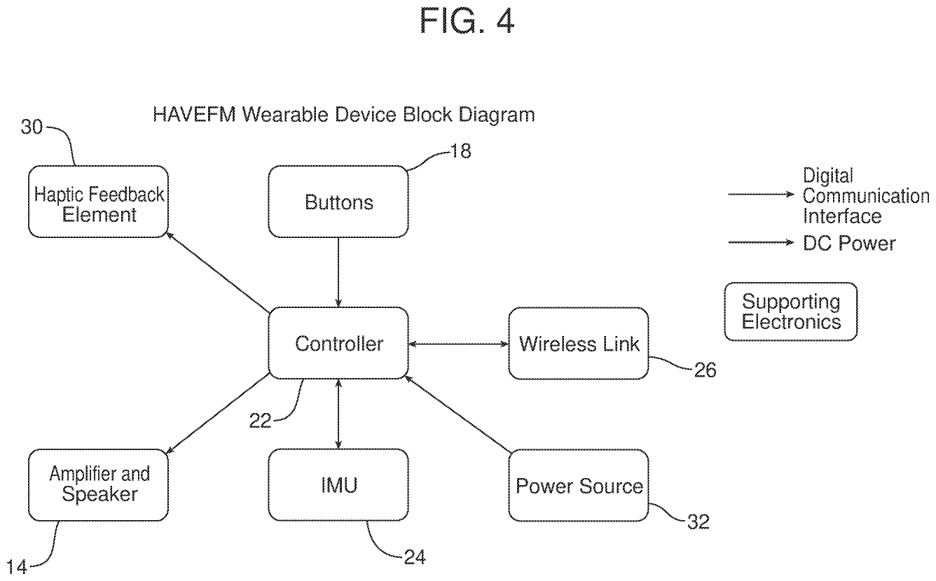

Reference is now made to FIGS. 3 and 4 which illustrate a device 10 used in a method of sport training. As illustrated in FIG. 3, the device 10 may be secured to the lower arm or wrist A of the user by means of a band 36 connected to the housing 12, or may be secured to another relevant body position or position on the club, bat, or racket. The band 36 may be, for example, an elastic band or a strap with a securing buckle.

For purposes of this application, the motion feedback device 10 may include the controller 22 connected to the amplifier and speaker 14, the motion sensor 24 and the haptic feedback element 30 all carried by the housing. The housing 12 may also carry (a) a rechargeable power source 32, (b) operator interface or control actuators 18, such as buttons, knobs, slides or the like, to adjust the operation of the device 10 and (c) the wireless communication feature 26 allowing wireless communication, such as Bluetooth communication between the controller 22 held in the housing 12 and remotely located supporting electronic devices such as a display monitor, personal computer or the like (not shown). In some embodiments, the amplifier and speaker 14 may also be remotely located instead of being carried by the housing 12 in order to reduce the packaging requirements and the size of the housing.

The motion feedback device illustrated in FIGS. 3 and 4 would be used to imitate or repeat the desired, proper motion of swinging the golf club C online. The fast motions associated with the golf swing are hard to observe visually, however, when the motion is sonified (auralization) to provide another input to another human sense, that helps in recognizing proper physical form.

While the sport training device 10 illustrated in FIGS. 3 and 4 relates to golf, it should be appreciated that the device 10 may be easily adapted for training in other sports such as, for example, tennis to improve one's swing, soccer to improve one's kicking stroke (by connection of the device 10 to the kicking leg), running by connection of multiple devices to the arms and legs, etc.

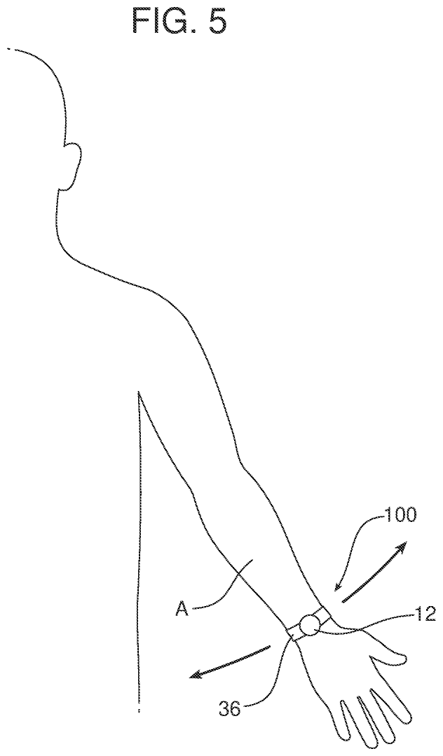

Reference is now made to FIG. 5 which illustrated a device used for physical rehabilitation. For this application, a user is either home or at a clinical physical rehabilitation session.

More specifically, the device 10 would consist of at least two components 100 and 200. The first component 100 would be worn on-body, mounted with limited intrusion to arm or leg or other artifact, with a compact, ergonomic design. See, for example, FIG. 5 showing the first component 100 of the device 10 attached to the arm A of the user by a band 36 connected to the housing 12. For some applications, the device 10 may include more than one component 100 worn on one or more limbs of the user. Those components 100 would provide combined feedback on all of the inputs from each limb upon which a device is worn. Such a device 10 supports complex rehab where more than one joint, limb, artifact, or prosthesis are involved. The wearable device 10 or first component 100 for this application may be the same as that for the device for sports training illustrated in FIG. 4.

The second component 200 is non-battery powered and stationary, and may be connected to the first component 100 wirelessly. The second component 200 would use information from the first component or components100 to provide the user with enhanced contextual feedback.

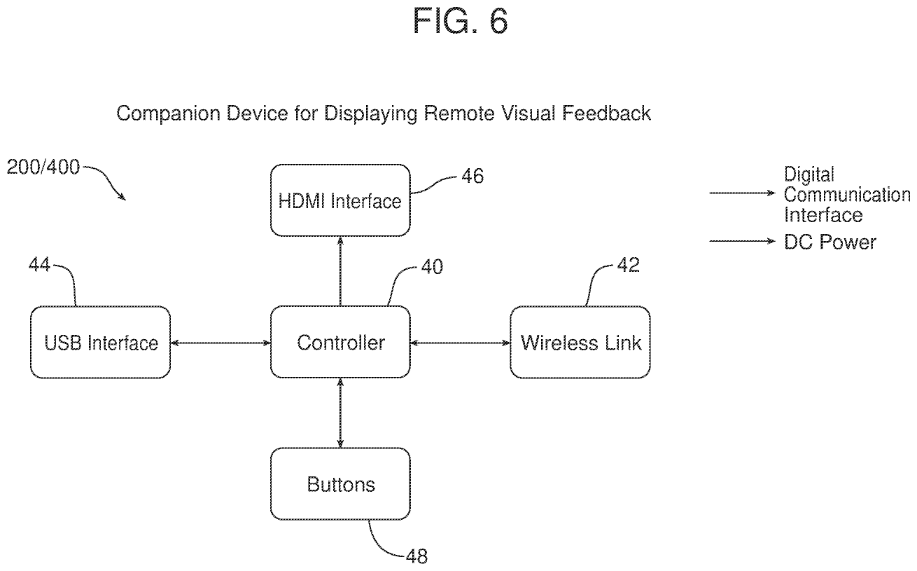

More specifically, as illustrated in FIG. 6, the second component 200 may include (a) a computing device 40 connected to a complimentary wireless communication feature 42, allowing wireless communication with the wireless communication feature 26 of component 100, (b) a USB interface 44, (c) a HDMI interface 46, allowing HDMI connection to devices such as a video monitor (not shown) and (d) control actuators 48, including various human interface features such as buttons, knobs or slides to allow operator adjustment of the second component 200. The second component 200 may include a power cord (not shown) for connection to a power source such as an electrical wall outlet or a rechargeable power source or both.

In this application, remote visual and acoustic feedback is provided by the capabilities of the second component 200 which has capability to drive a display and inform the user on a monitor or projector. Component 200 also has connectivity such that it can attach to a personal computer (PC) and supply the remote visual feedback information to the PC over the USB interface 44 for purposes of data compilation, processing and analysis.

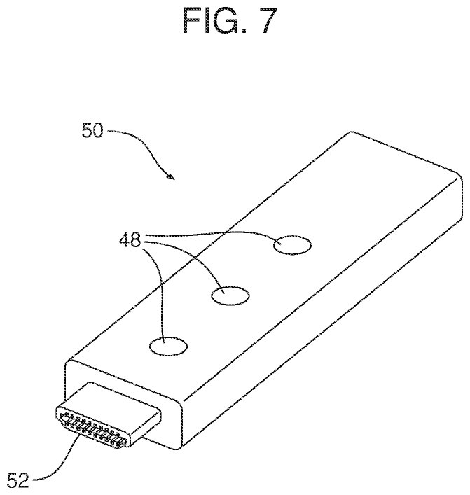

As illustrated in FIG. 7, the second component 200 may take the form of a USB data/power interface or stick 50 that may be directly connected to a personal computer through the connector 52.

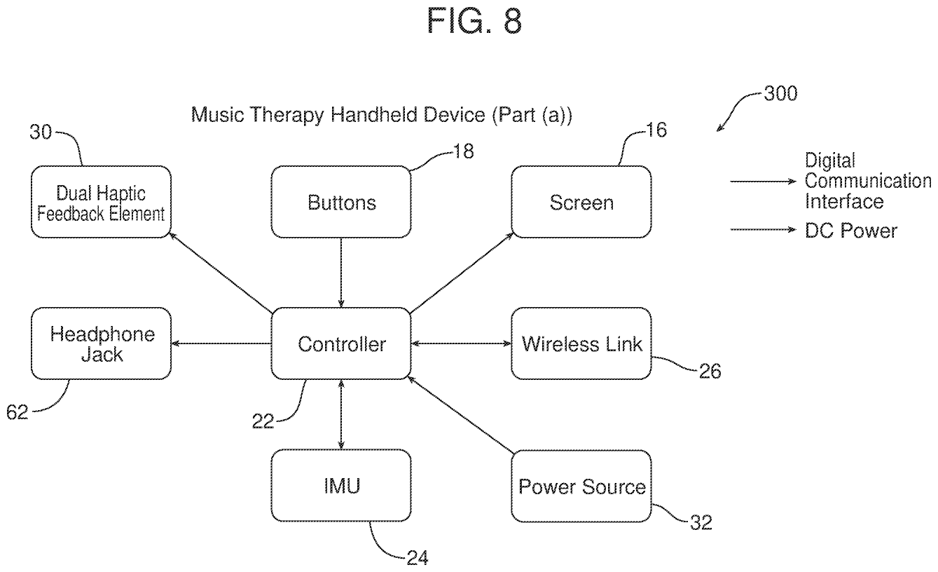

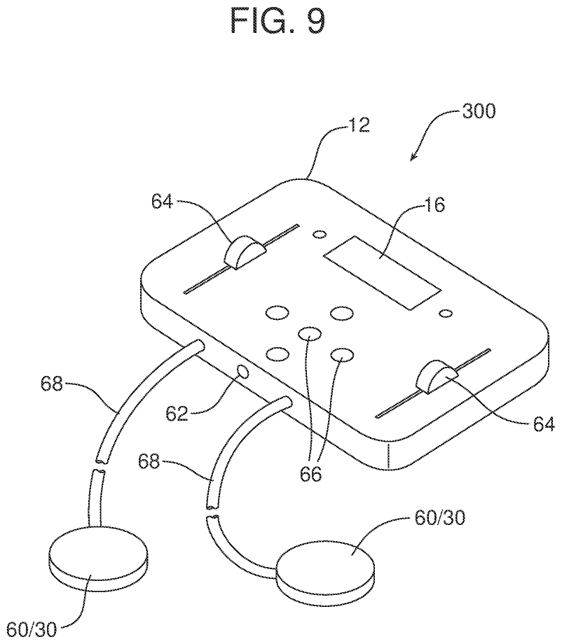

The device 10 may also be used for music therapy. For this application, the device 10 may once again include two components 300 and 400. The first component 300 illustrated in FIGS. 8 and 9 is a handheld device including a controller 22 connected to a motion sensor 24, a wireless communication feature 26, dual haptic feedback elements 30 in the form of two sealed vibrating pads 60, operator interface control slides 64 and buttons 66, a display screen 16, a headphone jack 62 and a rechargeable power source 32 all carried in a handheld housing 12.

In this embodiment of the device 10, haptic feedback is externalized in stereo to the two pads 60 at the end of the leads 68. Two channel (stereo) speakers or headphones (not shown) connected to the controller 22 through the headphone jack 62 or the wireless communication feature 26 are used to also provide dual channel acoustic feedback in this scenario as well. The second component 400 may be similar to the second component 200 illustrated in FIG. 6. Thus, remote visual feedback may be provided on a video monitor (not shown) connected to the HDMI interface 46.

The device 10 illustrated in FIGS. 6, 8 and 9 is then able to be used for bilateral stimulation, a core element of eye movement desensitization and reprocessing (EMDR) therapy, and also a common treatment for post-traumatic stress disorder (PTSD). Alternating left and right channel feedback is known to induce a calming effect in patients. The patient can observe patterns displayed on a TV or monitor (not shown) connected to the HDMI interface 46 of the second component 400. As noted above, the other forms of bilateral feedback available to the patient are haptic and auditory. Haptic is provided by the pads 60 that are held in the hands. A stereo headset connected to the device via the headphone jack 62 may be used for bilateral acoustic feedback. The user can also choose to combine several forms of feedback for themselves with the onboard device controls 64,66.

As should be appreciated, the motion feedback device 10 device may be used for the sonification or creation of sound sequences in response to any user-produced movement of the housing as dictated by a mapping of the controller, that is user selectable/programmable. For example, a simple mapping would be pitch angle to musical note/frequency, roll angle to volume and yaw angle to timber. The device provides a parameterized mapping or conversion of user-produced motion of the housing into sounds which allow the user to create a variety of sounds for whatever purpose.

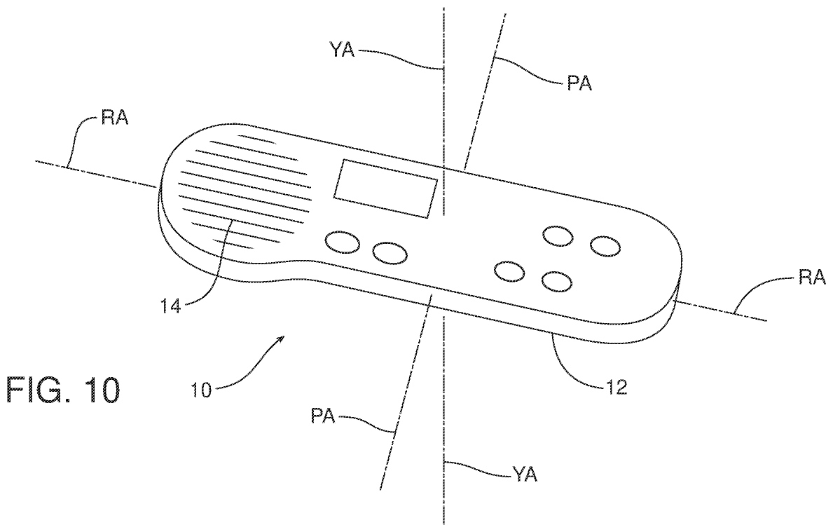

Reference is now made to FIG. 10 which illustrates the pitch angle PA, roll angle RA and yaw angle YA axes of the motion feedback device 10. The controller 22 is configured to include a mapping adapted for the creation of sound sequences in response to any user-produced movement (trajectory) of the housing 12 as detected by the motion sensor 24. That mapping relates (a) a pitch angle PA of the housing 12 to a first sound characteristic, (b) a roll angle RA of the housing to a second sound characteristic and (c) a yaw angle YA of the housing to a third sound characteristic allowing one to continuously produce sound in response to user-produced movement of the housing. The first, second and third sound characteristics may be selected from a group of sound characteristics consisting of musical note/frequency, volume and timber. There is no predetermined sound playback, all generated sounds are the original composition of the user as a result of the user movement of the housing 12.

In one possible embodiment, the controller 22 is configured so that the user-produced movement of the housing 12 creates the sound in real time having a musical note/frequency determined by the pitch angle PA of the housing, a volume determined by the roll angle RA of the housing and a timber determined by the yaw angle YA of the housing.

In another possible embodiment, the controller 22 is configured so that the user-produced movement of the housing 12 creates the sound in real time having a musical note/frequency determined by the pitch angle PA of the housing, a timber determined by the roll angle RA of the housing and a volume determined by the yaw angle YA of the housing.

In one possible embodiments, the controller 22 is configured so that the user-produced movement of the housing 12 creates the sound in real time having a musical volume determined by the pitch angle PA of the housing, a musical note/frequency determined by the roll angle RA of the housing and a timber determined by the yaw angle YA of the housing.

In one possible embodiment, the controller 22 is configured so that the user-produced movement of the housing 12 creates the sound in real time having a musical volume determined by the pitch angle PA of the housing, a timber determined by the roll angle RA of the housing and a musical note/frequency determined by the yaw angle YA of the housing.

In one possible embodiment, the controller 22 is configured so that the user-produced movement of the housing 12 creates the sound in real time having a musical timber determined by the pitch angle PA of the housing, a musical note/frequency determined by the roll angle RA of the housing and a volume determined by the yaw angle YA of the housing.

In one possible embodiment, the controller 22 is configured so that the user-produced movement of the housing 12 creates the sound in real time having a musical timber determined by the pitch angle PA of the housing, a volume determined by the roll angle RA of the housing and a musical note/frequency determined by the yaw angle YA of the housing.

Effects such as note bending, vibrato, reverb could also be mapped into an orientation or even the speed of movement in a given orientation. More complex mapping of orientation or velocity (linear or angular) in any of the given directions can be mapped to control the time or spectral envelope for modifications of the timber dynamically. This would be similar to the action of striking a percussive instrument such as a drum or piano, where the velocity and pressure before the strike can be mapped to an initial amplitude and decay of a time envelope. Or in the case of other effects such as a wah wah or voice effects box, orientation or velocity can be mapped into modulations of the spectral envelope of the sound being played.

Other mappings can be used to adjust tempo of accompanying soundtracks or add harmonies or chord changes. Such mappings could be program based on user preferences with an efficient graphical user interface, where users can set ranges and patterns in the sound and spatial/movement domains.

The sensory aids can help one learn how to generate original compositions using the motion feedback device 10. This includes the laser pointer 28 adapted so that projections or markings on a screen or wall can be identified by novices to help them learn to move and position the instrument for playing melodies, harmonies, or learning the elements of music. Additionally, a vibrational sensory unit 30 can also be added to a particular embodiment to help with timing (like a metronome) or an invisible conductor when playing in groups.

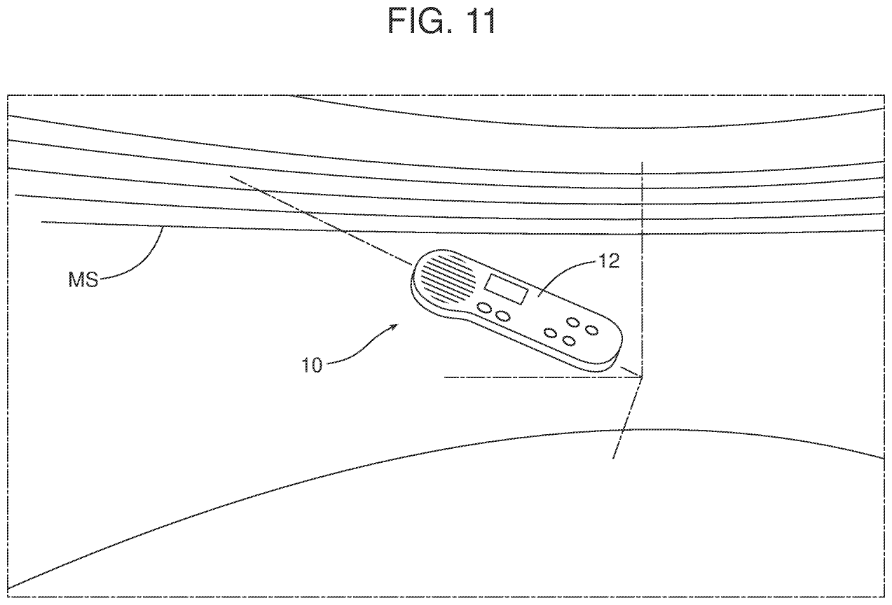

In at least one possible embodiment illustrated in FIG. 11, the handheld motion feedback device 10 may be equipped with mapping technology and an added visual aid (such as laser pointer 28) that may be used to point to note locations on a musical staff MS found on a paper document or projection screen or the like. In this example, the vibrational unit (haptic projection unit 30) would tell the user when certain note positions are to be pointed out.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. A motion feedback device, comprising:
a housing;
a speaker; and
a control module carried by said housing, the control module including a controller and a motion sensor wherein the controller is configured to include a mapping adapted for the creation of sound in response to any user-produced movement of the housing as detected by the motion sensor.

2. The motion feedback device of claim 1, wherein the mapping relates (a) a pitch angle of the housing to a first sound characteristic, (b) a roll angle of the housing to a second sound characteristic and (c) a yaw angle of the housing to a third sound characteristic.

3. The motion feedback device of claim 2, wherein the first, second and third sound characteristics are selected from a group of sound characteristics consisting of musical note/frequency, volume and timber.

4. The motion feedback device of claim 1, wherein the controller is configured so that the user-produced movement of the housing creates the sound in real time having a musical note/frequency determined by a pitch angle of the housing.

5. The motion feedback device of claim 4, wherein the controller is configured so that the user-produced movement of the housing creates the sound in real time having a volume determined by a roll angle of the housing.

6. The motion feedback device of claim 5, wherein the controller is configured so that the user-produced movement of the housing creates the sound in real time having a timber determined by a yaw angle of the housing.

7. The motion feedback device of claim 4, wherein the controller is configured so that the user-produced movement of the housing creates the sound in real time having a timber determined by a roll angle of the housing.

8. The motion feedback device of claim 7, wherein the controller is configured so that the user-produced movement of the housing creates the sound in real time having a volume determined by a yaw angle of the housing.

9. The motion feedback device of claim 1, wherein the controller is configured so that the user-produced movement of the housing creates the sound in real time having a volume determined by a pitch angle of the housing.

10. The motion feedback device of claim 9, wherein the controller is configured so that the user-produced movement of the housing creates the sound in real time having a musical note/frequency determined by a roll angle of the housing.

11. The motion feedback device of claim 10, wherein the controller is configured so that the user-produced movement of the housing creates the sound in real time having a timber determined by a yaw angle of the housing.

12. The motion feedback device of claim 9, wherein the controller is configured so that the user-produced movement of the housing creates the sound in real time having a timber determined by a roll angle of the housing.

13. The motion feedback device of claim 10, wherein the controller is configured so that the user-produced movement of the housing creates the sound in real time having a musical note/frequency determined by a yaw angle of the housing.

14. The motion feedback device of claim 1, wherein the controller is configured so that the user-produced movement of the housing creates the sound in real time having a timber determined by a pitch angle of the housing.

15. The motion feedback device of claim 14, wherein the controller is configured so that the user-produced movement of the housing creates the sound in real time having a musical note/frequency determined by a roll angle of the housing.

16. The motion feedback device of claim 15, wherein the controller is configured so that the user-produced movement of the housing creates the sound in real time having a volume determined by a yaw angle of the housing.

17. The motion feedback device of claim 14, wherein the controller is configured so that the user-produced movement of the housing creates the sound in real time having a volume determined by a roll angle of the housing.

18. The motion feedback device of claim 15, wherein the controller is configured so that the user-produced movement of the housing creates the sound in real time having a musical note/frequency determined by a yaw angle of the housing.

19. The motion feedback device of claim 1, further including (a) a laser to help guide the user-produced movements to achieve the orientations to produce a desired sound or sound sequence and (b) a haptic feedback element to provide a beat or a timing guide on when to make the user-produced movements and guide the velocity between the user-produced movements.

20. A method of music creation, comprising:
using the motion feedback device of claim 1 to provide visual and haptic feedback representative of user-produced motion and spatial orienting of the motion feedback device; and
generating audio feedback as the music creation in response to the user-produced motion and the spatial orienting of the motion feedback device.
